(19) United States
(12) Patent Application Publication
(10) Pub. No.: US 2009/0210209 A1
(43) Pub. Date: Aug. 20, 2009

(54) APPARATUS AND METHOD FOR SIMULATING EFFECTS OF SUBSTANCES

(75) Inventor: Eyal BARTFELD, Lexington, MA (US)

Correspondence Address: DEBORAH A. GADOR, P.O. BOX 4133, GANEL TIKVA, 55900, IL

(73) Assignee: IRODY INC, Lexington, MA (US)

(21) Appl. No.: 12/388,572

(22) Filed: Feb. 19, 2009

Related U.S. Application Data
(60) Provisional application No. 61/066,320, filed on Feb. 20, 2008.

(51) Int. Cl. G06G 7/60

(52) U.S. Cl. 703/11

(57) ABSTRACT

A method and system for simulating the effect of pharmaceutical substances inside a living body, the method including inputting medication details and pharmacokinetic and pharmacodynamic data of the medication, storing the input medication details and pharmacokinetic and pharmacodynamic data, calculating concentration and effect of the medication on at least one portion of a living body from the input medication details and the pharmacokinetic and pharmacodynamic data, and generating a visualization of the calculated concentration and effect on a virtual body.

### CROSS REFERENCE TO RELATED APPLICATIONS

This application claims benefit of U.S. Provisional Application Ser. No. 61/066,320 filed Feb. 20, 2008.

### FIELD OF THE INVENTION

The present invention relates to a simulator in general, and in particular, to a pharmaceutical simulator.

### BACKGROUND OF THE INVENTION

Medications in general, and in particular oral medications, are the most common treatment for most complaints. In recent years, the use of medications to prevent and treat chronic conditions has increased considerably. As a result, many people start taking medications at a relatively young age, on a routine basis, and for their entire life. However, when a patient leaves the doctor's office, the outcome of the treatment is largely dependent upon the patient's obedience with the doctor's instructions. It is known that compliance and adherence to a medication regimen are critical to ensuring the desired outcome.

Most patients do not have a science background. They simply follow doctors' orders without really understanding the reason behind these orders. Patients cannot see the substances moving and acting in their bodies. Their only feedback is the action of the substance(s). In many cases, the action is not dramatic nor is it immediate—making it difficult for patients to realize the relationship between taking medications as prescribed and achieving the maximal benefits from these medications. As an example, pain relieving pills are taken when needed and their action is noticeable and almost immediate—by reducing one's pain and fever. However, many medications are used for prevention, such as Statines for reducing the cholesterol level, and do not deliver any effect that is noticeable to the patient. The only feedback patients get is from a blood test once every few months or even once a year.

Pharmacokinetics and pharmacodynamics are branches of pharmacology dedicated to the determination of the fate of substances administered to a living organism. This pharmacokinetic data, often expressed in the form of mathematical equations, may include the extent and rate of absorption, distribution, metabolism and excretion of each individual compound. This data is also referred to as the ADME scheme. Absorption is the process of a substance entering the body. Distribution is the dispersion or dissemination of substances throughout the fluids and tissues of the body. Metabolism is the irreversible transformation of a substance and its daughter metabolites. Excretion is the elimination of the substances from the body. Pharmacokinetics data provides information about what the body does to the substance. Another branch of pharmacology, namely pharmacodynamics, explores what a drug does to the body, how the drug affects the target organ or organs, and how it affects other organs. More specifically, pharmacodynamics explores the relationship between medicine concentration and effect. Typically, pharmacokinetic and pharmacodynamic information is obtained by pharmaceutical companies as part of their drug development and approval process. Most often this information is expressed as mathematical equations.

In order to predict the behavior of medications in the human body, based on the pharmacodynamics and pharmacokinetics information, pharmaceutical simulators were developed. An example of such a simulator is Simcyp, provided by Simcyp Limited (http://www.simcyp.com). The pharmaceutical simulators perform the various calculations including absorption, distribution, metabolism and excretion of each of the substance in the medication, when taken at the recommended times or times that are specified by the researchers, and dosages, by an assumed, or simulated patient. The results of the calculations are displayed as graphs and may be time dependent. These simulators are known and are in use in research laboratories in biotechnology companies. However, the average person, who was not trained to interpret these graphs, will not be able to deduce the effect of the medication and their particular medicine schedule on their particular body. Moreover, an enormous number of details are generated by pharmaceutical simulators which cannot be understood by and are not relevant to the patient. In addition, these simulators do not provide the user with effective feedback, since they do not exemplify the effect of the medication in a perceptible manner. It will be appreciated that these simulations relate only to one medication at a time.

It is known that an immediate reward is a powerful motivation for people to comply with their regimen. Accordingly, there is a long felt need for a user friendly pharmaceutical simulator, and it would be very desirable to have a simulator which generates strong effective feedback for a patient taking medications and which can illustrate the interactions between a plurality of medications, as exists in real world situations.

### SUMMARY OF THE INVENTION

There is provided according to the present invention a system including software that simulates the passage of administered substances through the body and a device for providing a visualization thereof, preferably an animated visualization. The system includes a software that can run on a PC or remotely, on a central web server or computer system which is connected to users via the Internet, or on both. The system utilizes the times when each medication was consumed or is expected to be consumed by the particular user who is currently using the system, so the simulation is personalized for each individual user. Further, the system contains a data-base having absorption, passage, breakdown and excretion of each medication in the body, particularly pharmacodynamic and pharmacokinetic (or ADME) information. The system calculates how medications, nutrients, vitamins and other molecules administered into the body of a living organism get absorbed, circulated, reach target organs, are metabolized and extracted from the body. The calculations are carried out at least once, and preferably are repeated at different time intervals. This system includes a display engine which graphically displays the results of the calculations, preferably as an easy to understand, three-dimensional graphic representation of a living body.

There is thus provided, according to the invention, a method for simulating the effect of pharmaceutical substances inside a living body, the method including a inputting medication data, storing the input medication data together with pharmacokinetic and pharmacodynamic data of medications, generating, in a simulator coupled to the database, a visualization thereof on a virtual body representation of the user, and displaying the user's virtual body, including the time-dependant motion and effect of the various medications that user reported he or she have taken at the users reported times.

There is also provided, according to the invention, a system for simulating the effect of pharmaceutical substances inside a living body, the system including a user interface for inputting medication data, a database for storing the input medication data together with pharmacokinetic and pharmacodynamic data of medications, a simulator coupled to the database for generating a visualization thereof on a virtual body, and a display for displaying the user's virtual body.

According to one embodiment of the invention, the user interface is arranged to receive data of a single medication.

According to another embodiment, the user interface is arranged to receive data of a plurality of medications and to generate an integrated visualization of action and interaction therefore on the user's virtual body.

### BRIEF DESCRIPTION OF THE DRAWINGS

The present invention will be further understood and appreciated from the following detailed description taken in conjunction with the drawings in which:

FIG. 1 is a schematic block diagram illustrating a system for providing simulated visualization of medicinal substances in a living body, according to one embodiment of the present invention;

FIG. 2 is a flow chart illustrating a method for simulating the behavior of pharmaceutical substances in a living body, according to one embodiment of the invention; and

FIG. 3 is a storyboard illustration used as a pharmaceutical simulator data structure, according to one embodiment of the invention.

### DETAILED DESCRIPTION OF THE INVENTION

The present invention relates to a personalized computerized pharmaceutical simulator system for simulating the effect of one or more pharmaceutical substances inside a living body and providing a visual illustration thereof. The pharmaceutical simulator takes into account the absorption, distribution, metabolism, and excretion rate, during a given time period, for each of the substances. The concentration and the effect of each substance on one or more portions of the body, such as body organs or tissues, are calculated relative to the time that has passed since the consumption of the medication. In addition, the interactions between the different substances consumed may be calculated. The results of the calculations are graphically displayed, preferably as an illustration of one or more body organs, or the body as a whole, integrated with notations representing the concentration and effect of the substance on each organ. Preferably, the calculations are repeated more the once, each repetition calculating the concentration and effect relative to a different time duration, so as to create a sequence of time dependent graphic displays. Sequentially displaying the different graphic displays simulates the effect of the medicine taken over a period of time, preferably as an animated movie.

The terms user, consumer and patient will be used in this application interchangeably. The reason for this is because medications are consumed for reasons that are not only an acute disease. For example, people take cholesterol reducing medications without being defined as “sick”. Therefore, most people who consume any kind of medication are potential beneficiaries of this invention. Similarly, the terms drug, medication and pill, the terms image and picture, and the terms substance, drug and medication, and the terms visualization and simulation will be used interchangeably. In addition, a user does not have to use the system for himself, only. For example, a parent may use the system on behalf of their child, or a pet owner may use the system for knowing better about their pet's therapy, or in various rehabilitation settings to demonstrate the effects of alcohol and other addictive substances.

According to a preferred embodiment of the invention, the simulated values are provided per medication and per “compartment”, as a form of multi-compartment model. A multi-compartment model is a type of a mathematical model that describes the way medications are moving across selected compartments of the body. A compartment for the purpose of the current invention may be a pharmokinetic or an anatomical compartment. A pharmacokinetic compartment is a defined volume of body fluids, for example, the plasma. An anatomical compartment is an organ bounded by membranes or fasciae, such as a muscle.

According to a preferred embodiment of the invention, the method described herein is implemented as software running on a web server, where the server generates web information to be displayed over a user interface, and presented on a user's PC or any other user device having an input and a display device, such as a cellular phone. Other embodiments are also possible, in which the invention is implemented as software running on a PC (Personal Computer), a cell phone or over any other apparatus.

The operation of the pharmaceutical simulator begins with the user inputting the details of the medications. These details preferably include name, dosage and method and time of administration. All input details are stored in the simulator database, which may be a storage device in the computer having the pharmaceutical simulator, for example a cellular phone. Alternatively, the database may be a storage device in a remote location. In that case, a suitable network, such as Ethernet or a cellular data network, connects the input device to the database and to the server which processes the information. If desired, user details, such as the user's age, weight, genetic factors, such as capability of body cells to process various medications, effectiveness of various enzymes in the particular user's body, and other medical history details relevant to the concentration and effect of the medications he is taking, may also be input. The database also includes pharmacokinetic and pharamcodynamic data related to these medications. The simulator calculates the concentration and effect of the medications on different organs in the body. The results of the calculations are graphically represented and displayed on a human or animal body on a display device, preferably in an animated fashion.

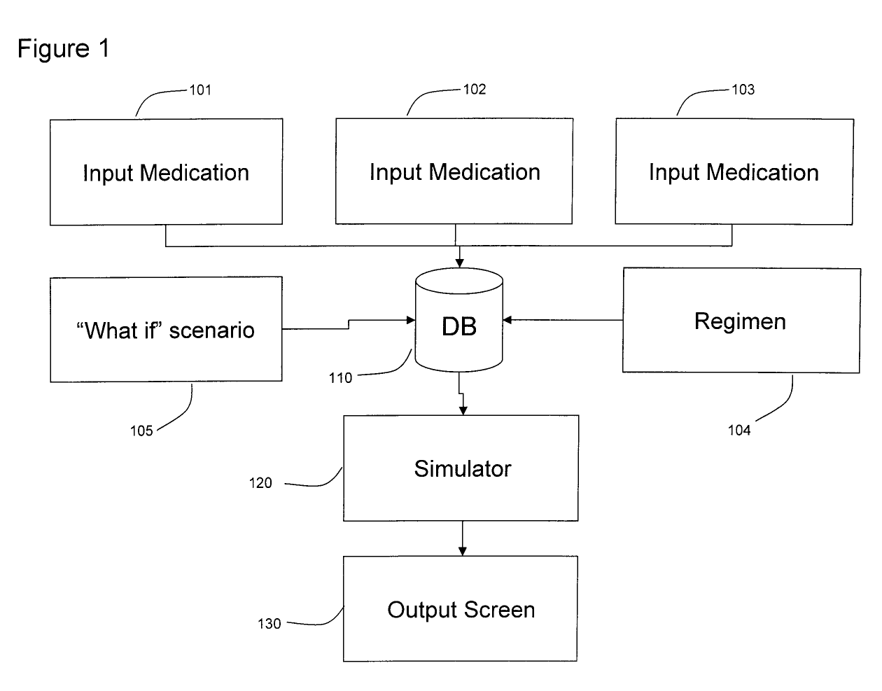

FIG. 1 is a block diagram illustrating a system for providing simulated visualization of medicinal substances in a living body, according to one embodiment of the present invention. The simulation is individualized and based on the user's medication or medications, data of which are input via a user interface (101,102,103). The medication input is stored in a database 110, and may be available for use in generating a personalized simulation at any time. The input information includes details of the medication taken, the time at which it is taken, and whether the medication is introduced to the body in an oral form, as an injection or in any other way.

According to one embodiment of the invention, a user inputs data concerning medication consumption upon taking the medication. In that case, the simulation may be generated at any time, based upon the medication consumed so far. As an example, user “A” consumes two pills in the morning, one pill at noon, and one additional medication in the evening.

Alternatively, the user may choose to input the details of one or more medications he already took, or he is intending to take in a certain period of time. In that case, the simulation will be generated based on the group of medications he took or intends to take in the specified period of time.

In addition, the user may define, via the interface, the duration of the simulation, i.e., the time period during which the effect of the medication on the body occurs which he wishes to simulate. For example, a user who wishes to visualize what his medications are doing to his body over a 24 hour period defines the duration of the simulation as 24 hours simulation. The simulation will be generated based on medication consumption prior to the 24 hour period. It will be appreciated that different users may want to visualize the action of their medication for shorter or longer periods of time.

Alternatively, the duration of the simulation may be determined by the pharmaceutical simulator based on the data related to the medications consumed. For example, the duration may be the time period beginning at the time of consumption of the medications and ending at the time of excretion of the medication residues. In addition, the user may select the organs or compartments for which he wishes to calculate the medications' effect and view a simulation.

According to another embodiment of the invention, medication data is input as a picture of the medication or of an identification sign on the medication package, such as a bar code or a label. The picture may be taken by the user using a cellular phone camera or a digital camera and then uploaded to a server running the system. The pictures are analyzed by means of an identification server having a medication details database. The server identifies the medication, based on the picture of the medications or of the identification sign, and provides medication details to the simulator. The identifying server is, preferably, a remote server. This method protects the user against errors in inputting data in the conventional manner of typing text. Nonetheless, a textual input via the Internet or over cell phones, as text messages, for example, is also possible.

A variety of communication networks can be used for communication between the input device and the identification server. According to a preferred embodiment of the invention, all these methods are made available to users to enable them to enter medication consumption data conveniently, correctly and in a timely manner, in order to provide a more precise visualization of the action of their own medications, as accurately as possible.

Still referring to FIG. 1, according to a preferred embodiment of the invention, the user may input his entire medication regimen via a user interface 104, based on which he may generate a simulation, assuming all medications have been taken exactly according to the regimen. Simulating the entire medication regimen is particularly useful for learning and explanation purposes, by a physician, for example, for the individual user. It will be appreciated that, in this fashion, interactions in the body between the various medications are also displayed and can be easily seen by the user. In addition, the user may input a hypothetical scenario of medication consumption via user interface 105, in order to simulate hypothetical or erroneous situations. Using the hypothetical scenario may help the user to gain knowledge regarding what would happen if he misses a dose, or if he takes a double dose by mistake. All the information regarding the different scenarios to be processed is stored in database 110. It will be appreciated that user interfaces 101,102,103,104 and 105 can be a single user interface.

Following the medication, regimen, or scenario input, a simulator 120 calculates the concentration and/or effect of each medication per selected compartment, according to the pre-stored data regarding the substances in each medication, and their pharmacodynamic and pharmacokinetic information. The pharmacodynamic and pharmacokinetic information in database 110 may be obtained from pharmaceutical companies, e.g., information prepared during the registration process for application of a new drug to authorities, such as the FDA (Food and Drug Administration) of the USA. Alternatively, the pharmacokinetic and pharamcodynamic information may be obtained from the developer or manufacturer of the substance.

Once the concentrations and the effects of each medication are calculated, the data is displayed on a display device 130 in the form of a simulation on a virtual human or animal body. It is appreciated that visualization on a virtual body may include a single or series of animated drawings, whether by hand or aided by a computer program, or can include one or more pictures, as taken by ultrasound, tomography, x-ray, etc. The information can be displayed as static pictures, moving graphs, or, according to a preferred embodiment of the invention, as an animated movie clip, e.g., showing the blood streaming in a virtual body, carrying the different medications to their target organs, and then showing the fate of these medications or substances as they are metabolized by the body, then excreted out of the body. In this way, the user can view a simulation over time of what is happening in his body, according to the data or scenario that he input. The animation clip may be created utilizing any known means, such as those used in computer games, animation video, or in other virtual entertainment, such as creating avatars in Second Life® (www.secondlife.com). According to a preferred embodiment of the invention, the user can fast forward or rewind the clip to get a better understanding of why it is important to take medications as prescribed, in order to get the best therapy outcomes and avoid errors.

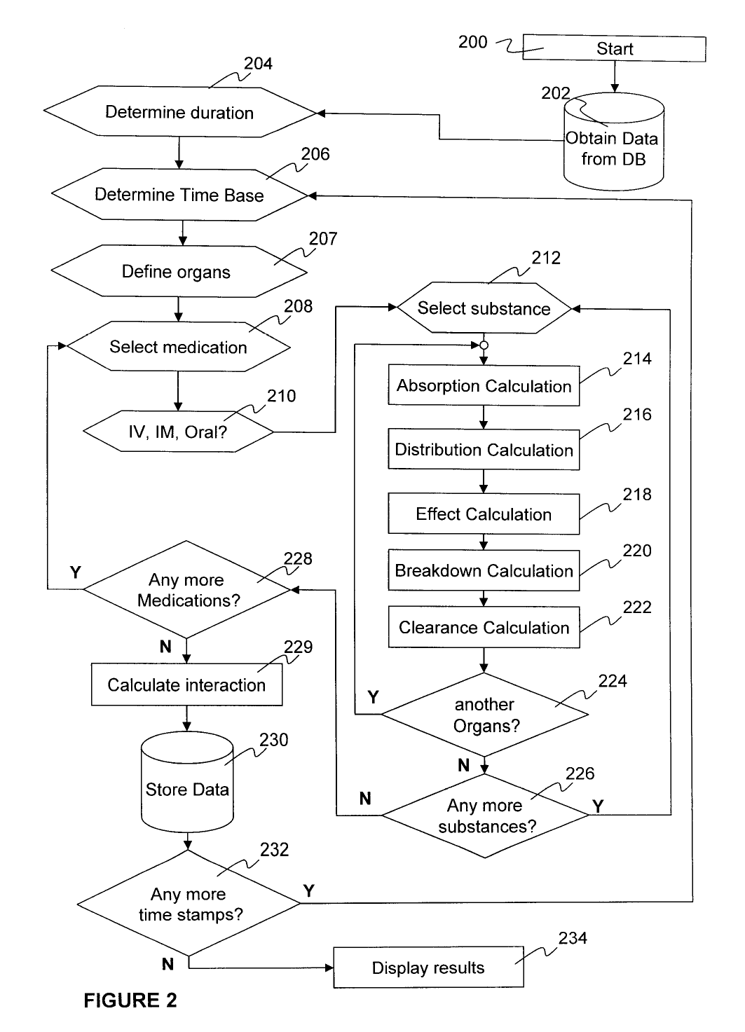

FIG. 2 is a flow chart illustrating a pharmaceutical simulation method, according to one embodiment of the invention. Prior to the simulation process, the user inputs to the database the medication details, a scenario or a medication regimen, and, preferably, the duration of the desired simulation, i.e., the time period for which the medications' effect on the body is sought. Once the user completes the input based on which he wishes to generate a simulation, he may prompt the simulator to begin processing the data (block 200). The necessary data is obtained from the database (block 202), and includes the user's input, as described in FIG. 1, as well as the relevant pharmacokinetic and pharamcodynamic information for each medication.

The pharmaceutical simulator first determines (block 204) the duration of the desired simulation, as input by the user, or as a default, according to the course of the medication or medications. The pharmaceutical simulator then determines (block 206) the time base of the calculation, which is the time increment between calculations for the simulation. The time base may vary based on the user selection or based on other information, such as the desired length of the simulation, or the duration of the medical treatment, and depends on the desired resolution of the simulation. According to a preferred embodiment of the invention, the time base default is one minute, whereby the calculations for the simulation are performed on a minute-by-minute basis throughout the duration of the simulation, although any other time base can, alternatively, be selected, such as by seconds or any other unit of time.

For each period of time set by the time base, calculations are performed which generate a frame in the simulation, each called a time stamp. For each time stamp, a calculation is performed individually for each substance in each medication that was input. It will be appreciated that each time stamp is associated with the results of the pharmacokinetic and pharmacodynamic calculations for the selected time period that has passed since the first set of calculations. As used herein, a set of calculations is the concentration and effect of each substance in one or more compartments at a time relative to the start of the simulation. Thus, in each time stamp, the set of calculations is performed one time.

The compartments or organs, for which simulation is to be performed, are selected (block 207) from a pre-determined set of compartments, selected by the user or the simulator, preferably the target organs or those relevant for the course of absorption and action of the medication being simulated. In addition, according to another embodiment of the invention, other compartments may be added to the simulation to show the effect of the medications or derivatives of the medications on other organs in the body. These other effects are sometimes referred to as side effects.

The simulation process is carried out on each medication separately, although the display can be the simulation of a single medication or of the effects and interactions of more than one medication. Thus, one of the medications input by the user is selected (block 208) to begin the calculation of the changes and effect on the body during the first time stamp. In addition, the route of administration is input (block 210), e.g., oral, intravenous, or intramuscular, which greatly affects the distribution time in the body of the medication and is taken into account by the simulator. For example, in case the medication is introduced to the body by injection to the blood stream, then the absorption calculation may be omitted.

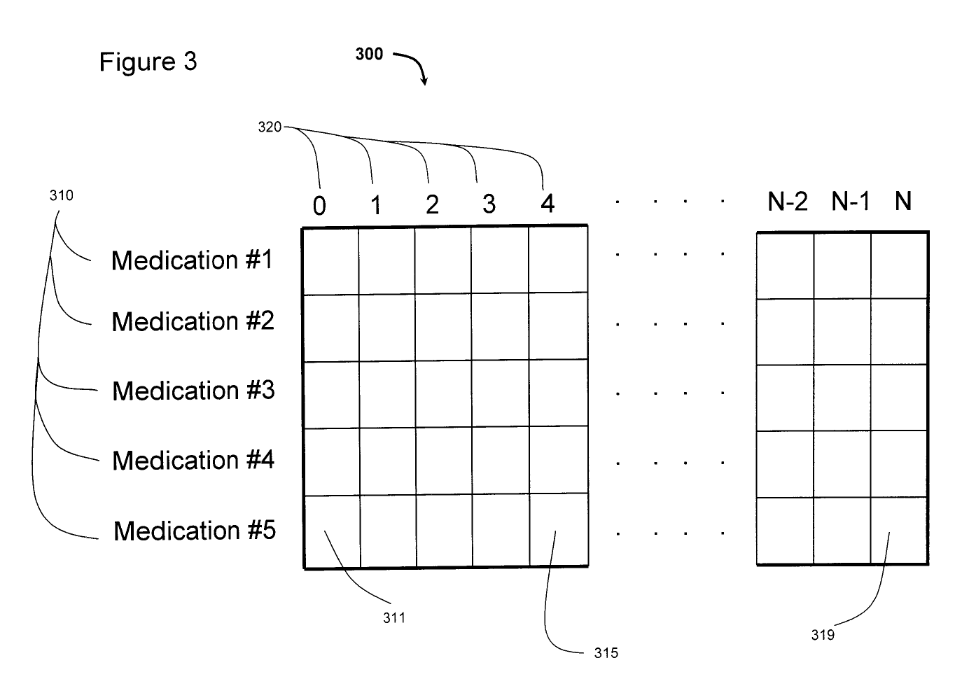

A substance to be simulated from the selected medication is selected (block 212). The first calculation is preferably the rate of absorption (block 214) of the substance from the gut to the blood stream. The result of the absorption level represents the level of the substance in the blood. The simulator then calculates (block 216) the rate of distribution, which is calculating the level at the target organ or target compartment. Next, the effect on the target organ is calculated (block 218). Then, the breakdown of the substance currently being calculated is found (block 220), and the clearance status is calculated (block 222). When the calculated substance also affects another organ (block 224), the calculations are repeated (blocks 214-222) for the target organ and the non-target organ. This is important, for example, when a substance is known to affect two organs, or the substance partially penetrates a few organs. If the medication includes more than one substance (block 226), the simulator repeats the calculation for each of the substances. These calculations may be repeated until all the substances in the medication have been simulated. Similarly, the calculations are repeated (block 228) for each medication input by the user or by the regimen. According to a preferred embodiment, interactions between the medications consumed by the user are also calculated (block 229). The results of each calculation are stored (block 230) in the simulator database, associated with that particular time stamp, preferably in a manner illustrated in FIG. 3 and described in detail below.

Once the simulator has performed all the calculations on the substances in each of the medications, the simulator moves to the next time stamp by increasing the time variant by one time base (block 232), and the calculations are repeated for each substance of each input medication. The last time stamp defines the end of the duration of simulation which was initially selected (block 204).

Following the calculation of the last time stamp, the simulator generates and displays a visual representation of the results of the calculations per time stamp (block 234), which were stored in the simulator database. It will be appreciated that one skilled in the art can use the results of the above calculations in any conventional fashion to generate a visualization of the corresponding changes in shape or function of various organs or the overall effect on the body, and represent these changes and/or effects in the visualization in any fashion.

The transformation from calculated results to a picture or a series of pictures that can be used in an animation clip is greatly dependant on the graphic reality that is required. As an example, one may display a two-dimensional sketch of the human body, showing the major organs inside and the major blood vessels. Each medication may get a different color and be displayed as round bubbles that flow inside the blood vessels. As an example, the size of the bubbles reflects the concentration of the substance or medication at that particular moment in the blood stream. As another example, the color intensity of each bubble may reflect the same parameter. Continuing with this example, the bubbles are carried with the blood stream onto the target organ, such as a muscle. Later in the clip, when a bubble representing a medication has reached a muscle, it gets absorbed by the muscle and disappears from the blood stream.

As another example, one may take a fully realistic graphic approach, having a transparent or semi transparent three dimensional representation of a human body, showing the blood vessels and the organs that are relevant for the medications being simulated, such as muscles, brain, liver and kidneys. The user may rotate the display and observe the clip from various angles or even zoom in on specific regions within the simulated body. In this example too, the various concentrations of medications or substances being simulated are shown as graphic metaphors described above. The advantage of such a realistic representation is to give people who never had a scientific education the notion of what is in their bodies and why it is important to take their medicines in a certain way. As another example, if the simulation is for pets, the three dimensional figure may be of a dog or a cat, as the case may be. A plurality of software tools are available for producing clips by overlapping small images over a background of a larger image to produce the desired clip. One example is Adobe Flash, provided by Adobe, USA.

The results are preferably displayed as an animated movie clip composed of a plurality of frames, each frame graphically representing the results in one time stamp, preferably in a lively representation, such as in a pictorial body. According to a preferred embodiment, the graphic representation is an illustration of the effects of one or more medications on one or more body organs or the entire body, integrated with colors or shades representing the substances' concentrations or effects. Alternatively, the results may be represented as a graph having a time axis or other graphic representation. Preferably, the display is a dynamic display, such as animation.

It should be noted that for each time stamp and for each medication there are a plurality of concentrations and effects that are calculated. For example, multiple values for concentration of the medications and/or their derivatives at this simulated moment in the blood, effect on different organs, and consternation at this given simulated moment of derivatives that are the result of its breakdown in the body, in the blood, for a medication may be calculated. For example, at a given time stamp, there are different concentrations of medication A in the blood, in the muscles and in the liver. The different concentrations are a function of current dose and of previous doses of that medication, and are dependent upon timing of intake of these doses. This further explains the benefit of a movie representation and the benefit of a user inputting his own actual schedule of consumption and also hypothetical schedules. The multiple calculations results may be stored in the storyboard, described in FIG. 3 below.

FIG. 3 is a storyboard data structure, according to one embodiment of the present invention. The storyboard 300 is a two dimensional chart having rows representing medications or substances 310 and columns representing time stamps 320. Thus, each cell in the storyboard chart stores the results of the calculations performed on one substance in one or more organs in a specific time stamp. The first time stamp 311, marked here as column 0, represents the starting point of the simulation, while the last time stamp 319, marked here as column N, represents the last point in the simulation. According to a preferred embodiment, multiple results may be stored in each cell, such as the concentration in different organs or compartments, as described in FIG. 2. In this case, each cell can be an array or a vector of results, and the entire data structure is three-dimensional. Alternatively, multiple instances of the story board data structure may be maintained, one for each parameter in the simulation or one for each compartment being simulated.

By the end of a single iteration of calculations of one time stamp, a column in the storyboard, corresponding to the current time, is filled in with the concentrations of all medications used during that particular time stamp. For example, column 315 in FIG. 3, which corresponds to time stamp number 4, is filled in. It will be appreciated that, when calculating the effect or concentrations of substances, the time stamp may have to be converted to units of time that can be placed into the pharmacodynamic and pharmacokinetic formulas. For example, each time stamp in the simulation may be expressed in minutes, while the formulas may include a time variant which is expressed in seconds. Based on each column, a graphic simulation may be illustrated representing the organ condition as affected by the medications, in a specific time stamp. The sequential graphic simulation of the affected organ provides a visual illustration of the process that occurs when consuming one or more medications.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A method for simulating the effect of pharmaceutical substances inside a living body, the method comprising:
inputting medication details and pharmacokinetic and pharmacodynamic data of said medication;
storing said input medication details and said pharmacokinetic and pharmacodynamic data;
calculating concentration and effect of said medication on at least one portion of a living body from said input medication details and said pharmacokinetic and pharmacodynamic data;
generating a visualization of said calculated concentration and effect on a virtual body.

2. The method according to claim 1, further comprising inputting user details, and said step of calculating includes calculating concentration and effect also from said user details.

3. The method according to claim 1, wherein said step of generating includes dynamically generating a changing visualization on said virtual body of said concentration and effect.

4. The method according to claim 3, wherein said visualization includes an animated movie.

5. The method according to claim 1, wherein said step of generating includes generating visualizations of at least two said medications showing interactions therebetween.

6. The method according to claim 1, wherein said step of generating a visualization includes generating a three dimensional visualization.

7. The method according to claim 2, wherein said user details include at least one detail selected from the group including a user's age, weight, genetic factors, and medical history.

8. A system for simulating the effect of pharmaceutical substances inside a living body, the system comprising:
a user interface for inputting medication details;
a database for storing said input medication details and pharmacokinetic and pharmacodynamic data of said medication; and
a simulator coupled to the database for calculating concentration and effect of said medication on at least one portion of a living body from said input medication details and said pharmacokinetic and pharmacodynamic data and generating a visualization thereof on a virtual body.

9. The system according to claim 8, further comprising a display for displaying said visualization.

10. The system according to claim 8, wherein said user interface is arranged to receive data of a single medication.

11. The system according to claim 8, wherein said user interface is arranged to receive data of a plurality of medications and to generate an integrated visualization of action and interaction of said plurality of medications on said virtual body.

12. The system according to claim 8, further comprising a user interface for inputting user details for storage in said database.

13. The system according to claim 12, wherein said user details include at least one detail selected from the group including a user's age, weight, genetic factors, and medical history.
